(19) United States
(12) Patent Application Publication
(10) Pub. No.: US 2014/0327384 A1
(43) Pub. Date: Nov. 6, 2014

(54) ELECTRONIC DEVICE AND CONTROL METHOD

(71) Applicant: FUJITSU LIMITED, Kawasaki-shi (JP)

(72) Inventors: Kazumi ABE, Kawasaki (JP); Kensuke ISHIDA, Yokohama (JP)

(21) Appl. No.: 14/334,756

(22) Filed: Jul. 18, 2014

Related U.S. Application Data
(63) Continuation of application No. PCT/JP2012/052563, filed on Feb. 3, 2012.

(51) Int. Cl. H02P 31/00; H02J 1/10

(52) U.S. Cl. CPC H02P 31/00; H02J 1/10
USPC 318/500

(57) ABSTRACT

An electronic device includes a first control circuit which controls a first drive circuit to drive a cooling device, a second control circuit which controls the first drive circuit, a switch circuit which connects one of the first and second control circuits to the first drive circuit, and a switch control unit which controls the switch circuit when there occurs a fault on the first control circuit, and switches a connection target of the first drive circuit from the first control circuit to the second control circuit.

### CROSS-REFERENCE TO RELATED APPLICATIONS

This application is a continuation application of International Application PCT/JP2012/052563 filed on Feb. 3, 2012 and designated the U.S., the entire contents of which are incorporated herein by reference.

### FIELD

The embodiments discussed herein are related to an electronic device provided with a cooling device such as a fan, and a related control method.

### BACKGROUND

An electronic device generates heat depending on power consumption. To allow an electronic device to steadily operate, it is necessary to maintain loaded electronic parts at a temperature not more than a specified level. Thus, an electronic device having a large amount of generated heat is loaded with a cooling device for suppressing an increase in temperature. In many cases, a fan which supplies cool air is included as a cooling device.

In an electronic device loaded with a cooling device, for example, a temperature sensor for measuring an internal temperature is loaded, and the cooling device is driven according to the temperature measured by the temperature sensor. With the method of driving the cooling device, the driving state of the cooling device maybe changed according to the measured temperature, thereby suppressing the power consumption by the cooling device.

The driving condition of the cooling device is changed according to the measured temperature by controlling a control device which executes a program. However, the control device which executes the program may be hung and not normally working after a running program stops as a failure. Once the hung-up occurs on the control device, the cooling operation is not performed according to a measured temperature.

Power consumption of an electronic device is not always reduced by the hung-up of a control device, that is, a fault which has occurred on the control device. The temperature may rise around the location of the electronic device (ambient temperature). These conditions refer to the possibility that a sufficient cooling operation is not performed by the fault which has occurred on the control device. Therefore, some electronic devices are designed against the faults which may occur on the control devices.

A conventional electronic device designed against a fault on a control device has two control circuits to control a drive circuit which drives a cooling device. One of the two control circuits (hereafter referred to as a first control circuit) is directly or indirectly controlled by the control device, and the other control circuit (hereafter referred to as a second control circuit) operates depending on whether or not a measured temperature has exceeded a specified temperature. Thus, with a conventional electronic device, a drive circuit is controlled by the second control circuit when the second control circuit is running, and the first control circuit controls a drive circuit when the second control circuit is not running. Thus, although the first control circuit is inoperative by a fault on the control device of the conventional electronic device, the cooling operation may be performed by the second control circuit which operates according to the measured temperature. The second control circuit controls the drive circuit to perform a sufficient cooling operation to continue the operation safely.

With a relatively large electronic device, temperature largely depends on the point where it is measured. For example, with a blade server, the temperature of each loaded server blade depends on its load (power consumption). Therefore, when there is a large difference in load as between each server blade, the temperature difference between the server blades may be largely different.

The above-mentioned electronic device uses one temperature sensor in controlling the operation of the second control circuit. For the above-mentioned reason, it is very difficult to appropriately operate the second control circuit using only one temperature sensor in a large electronic device, such as a blade server. If it is considered that there is a possibility that the load (power consumption) of a certain server blade will become heavier, it is preferable that a fault will quickly handled when the fault occurs on a control device.

For example, a document such as Japanese Laid-open Patent Publication No. 2005-100172, is known.

### SUMMARY

According to an aspect of the embodiments, an electronic device includes a first control circuit which controls a first drive circuit to drive a cooling device, a second control circuit which controls the first drive circuit, a switch circuit which connects one of the first and second control circuits to the first drive circuit, and a switch control unit which controls the switch circuit when there occurs a fault on the first control circuit, and switches a connection target of the first drive circuit from the first control circuit to the second control circuit.

The object and advantages of the invention will be realized and attained by means of the elements and combinations particularly pointed out in the claims.

It is to be understood that both the foregoing general description and the following detailed description are exemplary and explanatory and are restrictive of the invention.

### BRIEF DESCRIPTION OF DRAWINGS

FIG. 1 is an explanatory view of a configuration example of a processing system according to an embodiment of the disclosure;

FIG. 2 is an explanatory view of a more-detailed configuration of a blade server as a processing system according to an embodiment of the disclosure; and

FIG. 3 is an explanatory view of a method of handling a fault which occurs on a BMC.

### DESCRIPTION OF EMBODIMENTS

Embodiments of the present disclosure are described below in detail with reference to the attached drawings.

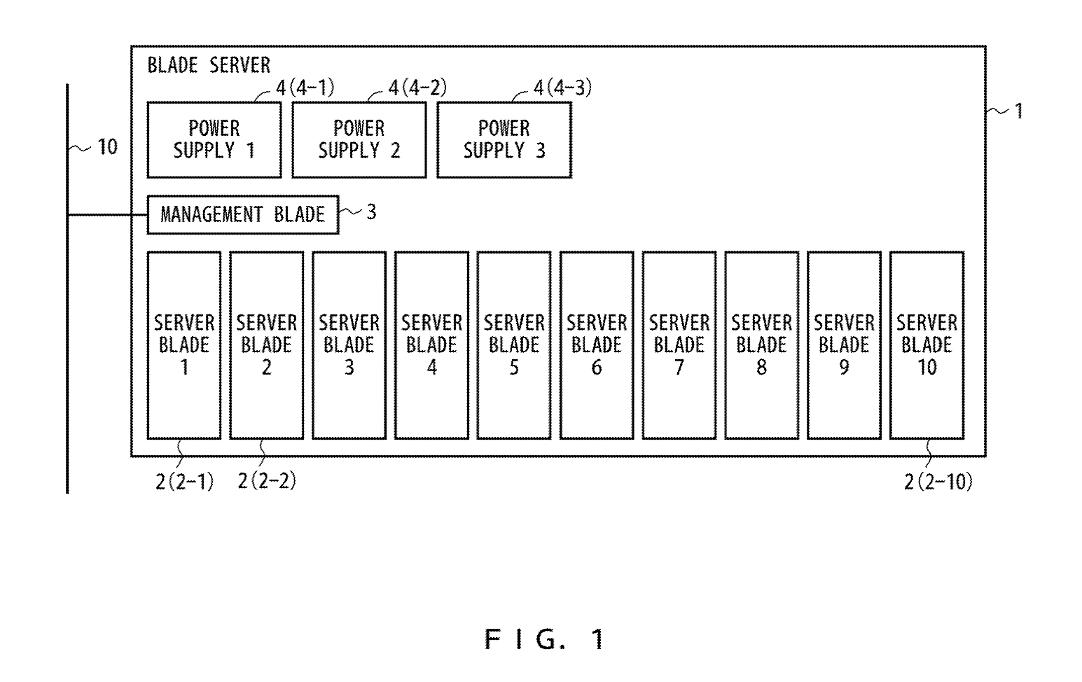

FIG. 1 is an explanatory view of a configuration example of an electronic device according to embodiments of the disclosure. According to embodiments, electronic device 1 is realized as a blade server loaded with a plurality of server blades 2 (2-1 through 2-10), each of which can function as a server. Electronic device 1 may be a device other than a blade server. That is, electronic device 1 is not limited to a blade server.

In embodiments, blade server 1 is connected to network 10 such as a LAN (local area network), and includes, in addition to the plurality of server blades 2, a management blade 3, a plurality of power supply devices 4 (4-1 through 4-3), and a fan (cooling device) not illustrated in FIG. 1. Network 10 is connected to, for example, a terminal device (e.g., but not limited to, at least one console) used by a worker although not specifically illustrated in the attached drawings.

FIG. 1 illustrates ten server blades 2-1 through 2-10, but the number of server blades 2 is not limited to ten. It is assumed that the number subsequent to the hyphen in reference numeral 2-1 etc. assigned to the server blade illustrated in FIG. 1 refers to the number assigned as an identifier (ID) to server blade 2, and the number of slot (s) into which the server blade 2 is inserted, but other suitable combinations of features may be made. If server blade 2 is not to be specified, or if an arbitrary server blade 2 is referred to, “2” is used as a reference numeral.

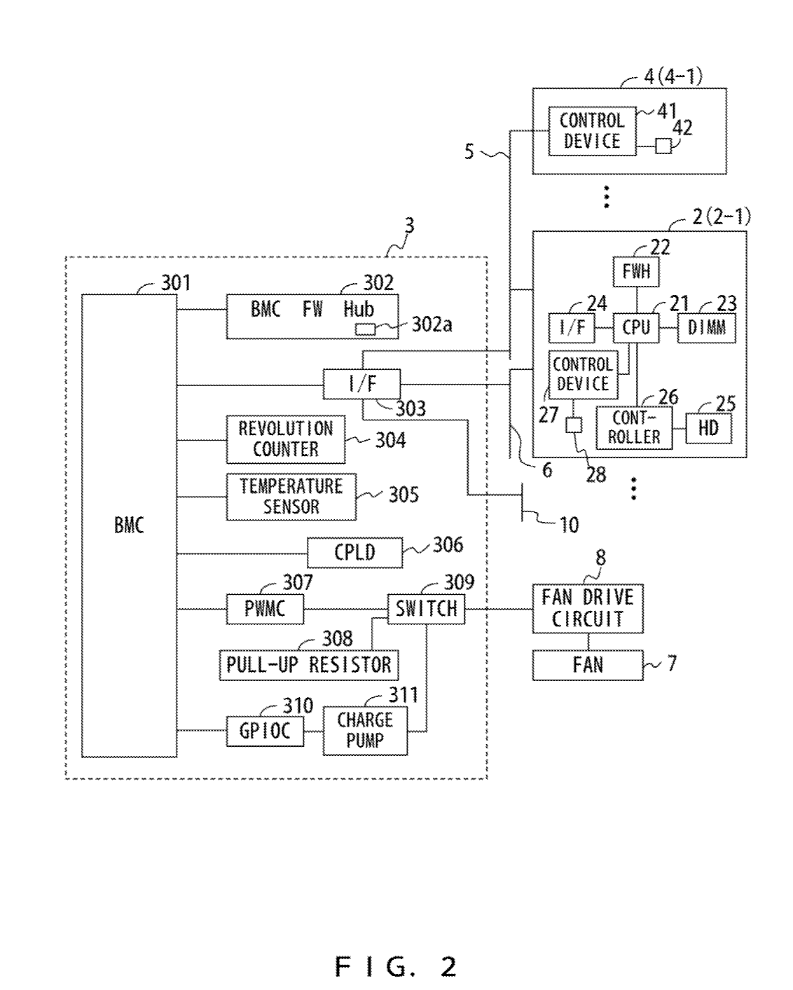

FIG. 2 is an explanatory view of a more detailed configuration of a blade server as an electronic device according to embodiments.

As illustrated in FIG. 2, blade server 1 is provided with fan 7 as a cooling device in addition to a plurality of server blades 2, a plurality of power supply devices 4, and management blade 3. Although FIG. 2 illustrates only one fan 7, a plurality of fans 7 are normally loaded into blade server 1.

In embodiments, each server blade 2, each power supply device 4, and management blade 3 are connected to bus 5. Each server blade 2 and management blade 3 are connected to LAN 6, and management blade 3 is further connected to the network 10. In addition, an FRU (field-replaceable unit) is connected to management blade 3, but it is omitted in FIG. 2.

In embodiments, each power supply device 4 is a 2-system power supply device. One system supplies power to the server blade 2, and is provided with a control device 41 which starts/stops the system. The control device 41 is connected to the bus 5. The control device 41 of each power supply device 4 starts or stops the system at an instruction of the management blade 3 through the bus 5.

In embodiments, each power supply device 4 may or may not includes one or more temperature sensor 42. The temperature sensor 42 is connected to the control device 41. The control device 41 notifies the management blade 3 of the temperature measured by the temperature sensor 42 with a specified timing or at a request from the management blade 3.

In embodiments, each server blade 2 includes a CPU 21, an FWH (firmware hub) 22, a memory module (expressed as a DIMM (dual inline memory module) in FIG. 2) 23, an interface (expressed as I/F in FIG. 2) 24, a hard disk device (expressed as an HD (hard disk) in FIG. 2) 25, a controller 26, a control device 27, and a temperature sensor 28. The control device 27 is connected to the bus 5, and the interface 24 is connected to the LAN 6. The configuration is an example, and is not limited to the configuration of the server blade 2.

In embodiments, FWH 22 is memory which stores a BIOS (basic input/output system). The BIOS is read to the memory module 23 and executed by the CPU 21. The hard disk device 25 stores an OS (operating system) and each type of application program (hereafter referred to as an application for short), and the CPU 21 reads the OS from the hard disk device 25 and executes it through the controller 26 after completing the activation of the BIOS. The communication through the interface 24 may be performed by the completion of the activation of the BIOS.

In embodiments, control device 27 controls the start/stop of the local server blade 2, that is, controls ON/OFF of the power supply. Thus, each server blade 2 may turns on and off the power supply by controlling the control device 27 at the instruction of the management blade 3. The control device 27 counts the time in which power has been supplied, and notifies the management blade 3 of the measured time as an operation period.

In embodiments, temperature sensor 28 is provided to measure the temperature for each server blade 2. The temperature sensor 28 is connected to the control device 27. The control device 27 notifies the management blade 3 of the temperature measured by the temperature sensor 28 with a specified timing or at a request from the management blade 3.

In embodiments, management blade 3 monitors and diagnoses each power supply device 4 and each server blade 2, and manages the entire blade server 1. As illustrated in FIG. 2, a fan drive circuit 8 which drives the fan 7 is connected to the management blade 3, and the management blade 3 controls the cooling of the blade server 1 by driving the fan 7 through the fan drive circuit 8.

In embodiments, and as illustrated in FIG. 2, the management blade 3 includes a BMC (baseboard management controller) 301, an FWH (expressed as a BMC FW hub in FIG. 2) 302, an interface (expressed as an I/F in FIG. 2) 303, a revolution counter 304, a temperature sensor 305, a CPLD (complex programmable logic device) 306, a PWM (pulse width modulation) controller (expressed as a PWMC in FIG. 2) 307, a pull-up resistor 308, a switch 309, a GPIO (general purpose input/output) controller 310, and a charge pump 311. The configuration is an example, and is not limited to the configuration of the management blade 3.

In embodiments, interface 303 enables the communication through the bus 5, the LAN 6, and the network 10 to be performed. The FWH 302 is memory which stores firmware 302a which is executed by the BMC 301. The BMC 301 reads the firmware 302a and executes it, by which the management blade 3 manages the entire blade server 1.

In embodiments, fan 7 is designed to output a pulse depending on the revolution speed to monitor whether or not a normal operation is being performed. The revolution counter 304 counts the number of pulses by inputting the pulse to the revolution counter 304. The counted number of pulses is processed as the number of revolutions. The BMC 301 confirms whether or not the fan 7 is running at a specified revolution speed by reference to the number of revolutions counted by the revolution counter 304.

In embodiments, CPLD 306 is used in, for example, resetting each power supply device 4. The BMC 301 performs the reset using the CPLD 306 when there is a power supply device 4 to be reset.

In embodiments, fan drive circuit 8 is a drive circuit controlled by a pulse wave. The longer the period in which a H (high) state is indicated is in one cycle of a pulse wave, the higher the revolution speed of the fan 7 is set. Thus, when a pulse wave indicating the H state in the entire cycle (signal wave whose level is fixed to H) is input, the fan drive circuit 8 drives the fan 7 at the highest revolution speed. The cooling power by the fan 7 reaches the maximum level by revolving the fan 7 at the highest revolution speed.

In embodiments, temperature sensor 305 is to measure the internal temperature of the management blade 3. The BMC 301 refers to the temperature measured by the temperature sensor 305, and further refers to the temperature collected from the power supply device 4 and each server blade 2, and determines the revolution speed of the fan 7. The BMC 301 instructs the PWM controller 307 to revolve the fan 7 at the determined revolution speed. The PWM controller 307 generates and outputs the pulse wave at the instruction from the BMC 301. The output pulse wave is not changed in the period of H until the next instruction.

In embodiments, switch 309 is connected to the PWM controller 307, the pull-up resistor 308, and the fan drive circuit 8. Thus, the switch 309 connects one of the PWM controller 307 and the pull-up resistor 308 to the fan drive circuit 8.

In the pull-up resistor 308, an internal power supply voltage is applied to one end, and the other end is connected to the switch 309. Therefore, a signal output from the pull-up resistor 308 to the switch 309 constantly indicates the H state. Therefore, the pull-up resistor 308 is a control circuit which controls the fan drive circuit 8 so that the fan 7 may be revolved at the highest revolution speed.

In embodiments, GPIO controller 310 outputs a pulse wave by the control of the BMC 301. The pulse wave is output to the charge pump 311.

In embodiments, charge pump 311 is a power supply device which is provided with a capacitor and a plurality of switching elements. The charge pump 311 generates an output voltage by superposing on the input voltage a voltage obtained by charging the capacitor. The pulse wave output by the GPIO controller 310 is used in switching each switching element.

In embodiments, signal (output voltage) of the charge pump 311 is used in switch control of the switch 309. When the signal of the charge pump 311 indicates the H state, the switch 309 connects the PWM controller 307 to the fan drive circuit 8, and when the signal of the charge pump 311 indicates the L (low) state, the switch 309 connects the pull-up resistor 308 to the fan drive circuit 8.

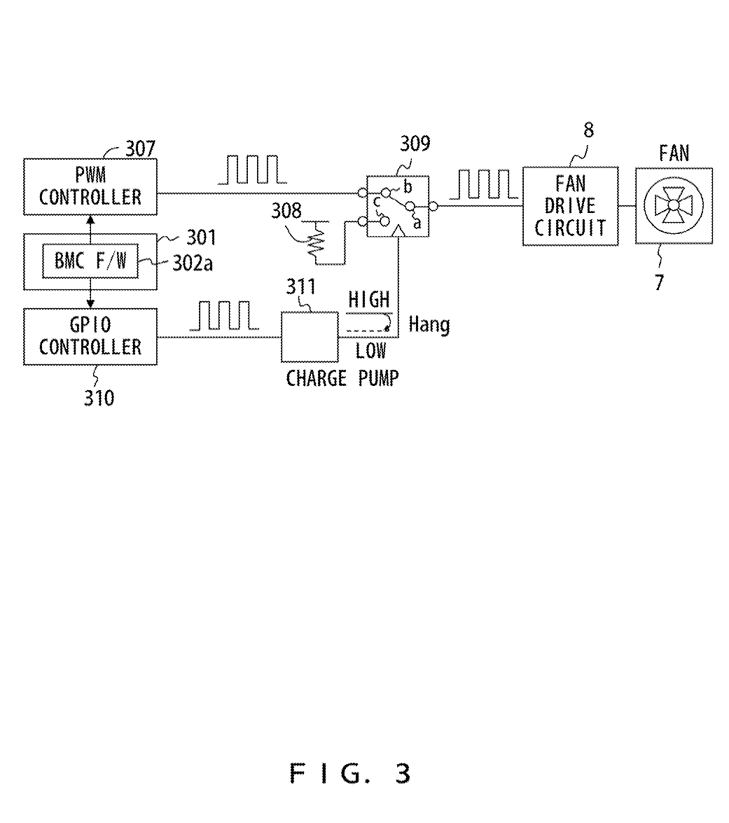

FIG. 3 is an explanatory view of a method of handling a fault which occurs on the BMC. Next, a handling method of embodiments is described with reference to FIG. 3.

In embodiments, BMC 301 performs control by executing stored firmware 302a. When there occurs a fault on BMC 301, or for example, when firmware 302a freezes, locks or hangs, the PWM controller 307 continues outputting the pulse wave at the final instruction from the BMC 301. Therefore, the fan 7 is not driven in dependance upon the status of blade server 1.

On the other hand, GPIO controller 310 outputs a pulse wave at the instruction of the BMC 301. Therefore, when a fault occurs on the BMC 301, no instruction is output from the BMC 301, and the GPIO controller 310 does not output a pulse wave. As a result, the state of the signal output from the charge pump 311 changes from the H state to the L state, and the switch 309 connects the pull-up resistor 308 to the fan drive circuit 8. The change of the signal output by the charge pump 311 from the H state to the L state is made immediately after the input of the pulse wave to the charge pump 311 stops.

In embodiments, switch 309 is provided with contact points a through c. The contact point a is a common contact point to the contact points b and c. When the signal from the charge pump 311 indicates the H state, the switch 309 connects the contact point a to the contact point b, and when the signal indicates the L state, the switch 309 connects the contact point a to the contact point c. Therefore, the PWM controller 307 is connected to the contact point b, and the pull-up resistor 308 is connected to the contact point c.

As described above, when no pulse wave is input to the charge pump 311, the signal output by the charge pump 311 immediately changes from the H state to the L state. In embodiments, therefore, when a fault occurs on the BMC 301, the connection target of the fan drive circuit 8 is immediately switched by the switch 309 from the PWM controller 307 to the pull-up resistor 308. When the fan drive circuit 8 is connected to the pull-up resistor 308, the fan drive circuit 8 drives the fan 7 at the highest revolution speed. Thus, when there occurs a fault on the BMC 301, the fan 7 may performs its cooling operation quickly without fail.

According to embodiments, the output voltage of the charge pump 311 is changed depending on whether or not there occurs a fault on the BMC 301. However, the physical quantity of the change which is made depending on the presence/absence of an occurrence of a fault may be made by anything other than the output voltage of the charge pump 311. For example, the GPIO controller 310 may directly detect whether or not the GPIO controller 310 outputs a pulse wave. A change in amplitude of a pulse wave may also be detected. Thus, the physical quantity is not limited by a voltage etc. According to embodiments, fan drive circuit 8 controls a PWM, but the drive circuit which drives the fan 7 is not limited to a drive circuit which performs the PWM control. The control system used by the fan drive circuit 8 is not specifically restricted. The cooling device is also not restricted to the fan 7. The electronic device may be loaded with a plurality of different types of cooling devices. Application of embodiments may be performed depending on the cooling device loaded into the electronic device, the type of the cooling device, the drive circuit which drives the cooling device, etc.

In a system according to embodiments, a cooling device may be driven although there occurs a fault on the control device which controls the drive of a cooling device according to a program.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic device comprising:
a first control circuit which controls a first drive circuit to drive a cooling device;
a second control circuit which controls the first drive circuit;
a switch circuit which connects one of the first and second control circuits to the first drive circuit; and
a switch control unit which controls the switch circuit when there occurs a fault on the first control circuit, and switches a connection target of the first drive circuit from the first control circuit to the second control circuit.

2. The electronic device according to claim 1, wherein
the switch control unit includes a second drive circuit whose output physical quantity is controlled by a control device which controls the first control circuit, and controls the switch circuit based on a change in physical quantity output by the second drive circuit.

3. The electronic device according to claim 2, wherein
the second drive circuit is a power supply circuit which generates a voltage as the physical quantity by a switching operation performed by one or more switching elements.

4. The electronic device according to claim 1, wherein
the second control circuit controls the first drive circuit so that maximum cooling power of the cooling device may be obtained.

5. A control method comprising:
when a control device controls a first drive circuit which drives a cooling device through a first control circuit, enabling a second control circuit which controls the drive circuit to connect to the first drive circuit;
allowing the control device to control a second drive circuit whose output physical quantity changes according to control contents; and
switching a connection target of the first drive circuit from the first control circuit to the second control circuit based on a change in physical quantity output by the second drive circuit.
